(19) United States
(12) Patent Application Publication
(10) Pub. No.: US 2019/0147093 A1
(43) Pub. Date: May 16, 2019

(54) DATA COLLECTION METHOD, INFORMATION PROCESSING APPARATUS, AND DISTRIBUTED PROCESSING SYSTEM

(71) Applicant: FUJITSU LIMITED, Kawasaki-shi (JP)

(72) Inventors: Kento Ikkaku, Kawasaki (JP); Kouichirou AMEMIYA, Kawasaki (JP)

(73) Assignee: FUJITSU LIMITED, Kawasaki-shi (JP)

(21) Appl. No.: 16/165,488

(22) Filed: Oct. 19, 2018

(30) Foreign Application Priority Data
Nov. 15, 2017 (JP) 2017-220390

(51) Int. Cl. G06F 17/30

(52) U.S. Cl. CPC G06F 17/30545; H04L 67/10; G06F 17/30598

(57) ABSTRACT

A data collection method includes extracting, by a first information processing apparatus, a predetermined resource that takes much time to search an information processing apparatus satisfying a request resource amount; notifying information related to the extracted predetermined resource to a second information processing apparatus that belongs to a first group of the first information processing apparatus; periodically collecting, by a second information processing apparatus, resource amounts of the plurality of resources to be collected from information processing apparatuses belonging to a second group; acquiring an resource amount of the predetermined resource of the information processing apparatuses belonging to the second group from the collected resource amounts at a predetermined timing; when the acquired resource amount satisfies a predefined resource amount, periodically notifying apparatus information related to the second group and the resource amounts to be collected by the second information processing apparatus to the first information processing apparatus.

### CROSS-REFERENCE TO RELATED APPLICATION

This application is based upon and claims the benefit of priority of the prior Japanese Patent Application No. 2017-220390, filed on Nov. 15, 2017, the entire contents of which are incorporated herein by reference.

### FIELD

The embodiments discussed herein are a data collection method, an information processing apparatus, and a distributed processing system.

### BACKGROUND

It has been known that each edge server connected to a network autonomously distributes tasks to other edge servers at a high load. For example, each edge server periodically collects from resource usage ratios of all resources from all edge servers. When a processing load concentrates on a particular edge server, the edge server distributes tasks to edge servers that meet the demand. Related art is disclosed in Japanese Laid-open Patent Application Publication Nos. 2005-251160, 2004-318594, and 2004-341912, and so forth.

However, as a first problem, when each edge server periodically collects from the resource usage ratios of all resources from all edge servers, the number of messages at the collection becomes too large.

To suppress the number of messages from becoming too large, each edge server may form a group with adjacent edge servers, and periodically collects the usage state of each resource in the group. However, as a second problem, when the processing load concentrates on a particular edge server, if tasks may not be distributed among the edge servers in the group, it is requested to search distributed targets by a hop-by-hop method, taking much time. In consideration of such situation, it is desirable to reduce the resource search time while suppressing an increase in the number of messages.

### SUMMARY

According to an aspect of the embodiments, a data collection method executed by a distributed processing system having a plurality of groups, the plurality of groups each having a plurality of information processing apparatuses, the data collection method includes extracting, by a first information processing apparatus among the plurality of information processing apparatuses, a predetermined resource that takes much time to search an information processing apparatus satisfying a request resource amount from among a plurality of resources to be collected; notifying information related to the extracted predetermined resource to a second information processing apparatus that belongs to a first group of the first information processing apparatus; periodically collecting, by a second information processing apparatus among the plurality of information processing apparatuses, resource amounts of the plurality of resources to be collected from information processing apparatuses belonging to a second group other than the first group, the second information processing apparatus belonging to the second group; acquiring an resource amount of the predetermined resource of the information processing apparatuses belonging to the second group from the collected resource amounts at a predetermined timing; and when the acquired resource amount satisfies a predefined resource amount, periodically notifying apparatus information related to the information processing apparatuses belonging to the second group and the resource amounts of the plurality of resources to be collected by the second information processing apparatus to the first information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of a distributed processing system according to Embodiment 1;

FIG. 2 is a diagram for describing previous search resource determination according to Embodiment 1;

FIG. 3 is a diagram for describing relationship between the average number of search hops and scarcity level;

FIG. 4 is a diagram for describing periodical notification according to Embodiment 1;

FIG. 5 is a diagram illustrating an example of a flow of data collection processing according to Embodiment 1;

FIG. 6 is a diagram illustrating an example of a sequence of data collection processing according to Embodiment 1;

FIG. 7 is a table illustrating an example of scarcity level information;

FIG. 8 is a table illustrating an example of request frequency information;

FIG. 9 is a table illustrating an example of resource value information;

FIG. 10 is a table illustrating an example of address information;

FIG. 11 is a table illustrating an example of request resource information;

FIG. 12 is a table illustrating an example of data information;

FIG. 13 is a table illustrating an example of task information;

FIG. 14 is a table illustrating an example of periodical notification;

FIG. 15 is a table illustrating an example of resource search request;

FIG. 16 is a table illustrating an example of previous search request;

FIG. 17 is a table illustrating an example of re-search request;

FIG. 18 is a flow chart illustrating an example of processing of a previous search resource determination unit according to Embodiment 1;

FIG. 19 is a flow chart illustrating an example of processing of a periodical notification unit according to Embodiment 1;

FIG. 20 is a flow chart illustrating an example of processing of a resource search unit according to Embodiment 1;

FIG. 21A is a flow chart of an example of processing of a response unit according to Embodiment 1 (1);

FIG. 21B is a flow chart of an example of processing of the response unit according to Embodiment 1 (2);

FIG. 22A is a flow chart of an example of processing of the registration unit according to Embodiment 1 (1);

FIG. 22B is a flow chart of an example of processing of a registration unit according to Embodiment 1 (2);

FIG. 23 is a flow chart illustrating an example of task scheduler processing according to Embodiment 1;

FIG. 24 is a diagram illustrating an example of a flow of data collection processing according to Embodiment 2; and

FIG. 25 is a diagram illustrating an example of a computer that executes a data collection program.

### DESCRIPTION OF EMBODIMENTS

Embodiments of a data collection method, an information processing apparatus, and a distributed processing system, which are disclosed in of this application, will be described below in detail with reference to figures. The embodiments is not limited to this.

### Embodiment 1

[Configuration of Distributed Processing System]

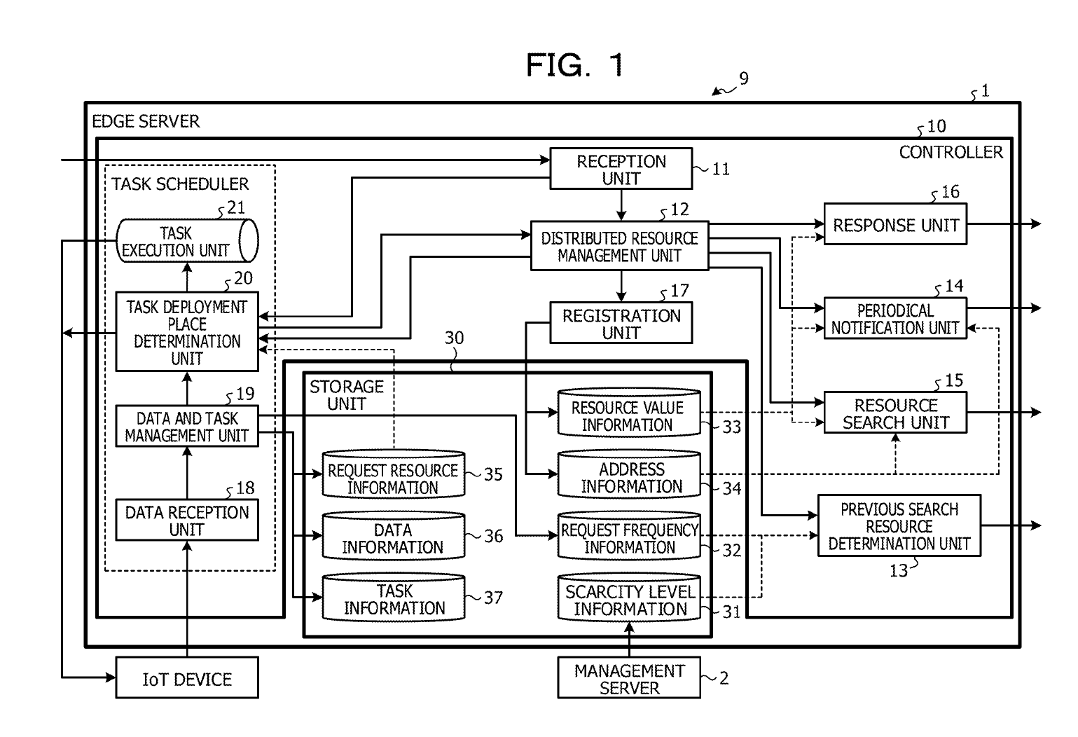

FIG. 1 is a diagram illustrating a functional configuration of a distributed processing system according to Embodiment 1. In a distributed processing system 9, to distribute tasks when a processing load concentrates on an own edge server (ES) 1, the own edge server 1 requests to recognize the resource amount of resources of other edge servers 1. For this reason, each edge server 1 periodically collects the amount of all resources from the edge servers belonging to a group, and previously collects server information related to the edge servers 1 out of the group that satisfy the request resource amount for a resource with high scarcity level. Hereinafter, ES is an abbreviation for the edge server.

The “group” described herein refers to a collection of the edge servers 1 each having a small delay in the network, and the edge servers 1 overlappingly belong to the group. For example, each edge server 1 belongs to a plurality of groups.

The “scarcity level” described herein refers to the extent to which a resource does not satisfy the request resource amount. For example, the “scarcity level” refers to a ratio of the edge servers that do not satisfy the request resource amount for the resource to all edge servers. The resource with high scarcity level represents the resource for which the number of edge servers that do not satisfy the request resource amount is larger than other resources. For the resource with high scarcity level, the number of edge servers that satisfy the request resource amount is small. For this reason, when periodically collecting the resource amount, the edge server 1 grasps server information related to the edge servers 1 out of the group that satisfy the request resource amount for the resource with scarcity level.

The distributed processing system 9 includes the plurality of edge servers 1 and a management server 2. The plurality of edge server 1 are interconnected via the network. The plurality of edge server 1 each are connected to the management server 2 via the network.

The management server 2 monitors loads of the plurality of edge servers 1 in the distributed processing system 9. For example, the management server 2 calculates the scarcity level of all resources collected from the edge server 1 every predetermined time. The management server 2 transmits the scarcity level of all resources to all edge servers 1 at a predetermined timing. The predetermined timing may be a timing at which the scarcity level of any of all resources changes, or a predetermined regular or irregular timing.

The edge server 1 includes a controller 10 and a storage unit 30.

The controller 10 corresponds to an electronic circuit such as a central processing unit (CPU). The controller 10 has an internal memory that stores a program prescribing various processing procedures and control data, and uses the program or the data to execute various processing. The controller 10 includes a reception unit 11, a distributed resource management unit 12, a previous search resource determination unit 13, a periodical notification unit 14, a resource search unit 15, a response unit 16, and a registration unit 17. In addition, the edge server 1 includes a data reception unit 18, a data and task management unit 19, a task deployment place determination unit 20, and a task execution unit 21. The data reception unit 18, the data and task management unit 19, the task deployment place determination unit 20, and the task execution unit 21 are included in a task scheduler.

The storage unit 30 is a semiconductor memory element such as a Random Access Memory (RAM) and a flash memory, or a storage device such as a hard disc and an optical disc. The storage unit 30 includes scarcity level information 31, request frequency information 32, resource value information 33, address information 34, request resource information 35, data information 36, and task information 37.

The scarcity level information 31 is information related to the scarcity level for each resource. For example, the scarcity level information 31 is information related to the average number of search hops requested to satisfy the request resource amount acquired from the scarcity level for a resource. For example, the scarcity level is a ratio of the edge servers that do not satisfy the request resource amount for the resource to all edge servers. Accordingly, as the scarcity level for the resource is higher, the average number of search hops requested to satisfy the request resource amount increases. On the contrary, as the scarcity level for the resource is lower, the average number of search hops requested to satisfy the request resource amount decreases. That is, the scarcity level information 31 applies information related to the average number of search hops as the information related to the scarcity level. An example of scarcity level information 31 will be described later.

The request frequency information 32 is information related to the request frequency for each resource. An example of request frequency information 32 will be described later.

The resource value information 33 is information related to resource values of the edge server 1 in the group and the edge server 1 out of the group. The resource value of the edge server 1 in the group is the resource values to all resources. The resource value of the edge server 1 out of the group is the resource value for the resource determined by convolution of the scarcity level information 31 and the request frequency information 32 for each resource. For example, convolution may be addition or multiplication. Hereinafter, convolution will be described as multiplication. An example of resource value information 33 will be described later.

The address information 34 is information related to addresses of the edge servers 1 in the group and addresses of the edge servers 1 out of the group. In the address information 34, in the case where the request resource is present out of the group when the request resource has depleted in the group, a flag indicating that the request resource is being searched is associated with the address. An example of address information 34 will be described later.

The request resource information 35 is information related to the resource (request resource) requested for each task. In the request resource information 35, the request resource requested by the task is associated with the resource usage amount. An example of request resource information 35 will be described later.

The data information 36 is information related to processing target data. An example of data information 36 will be described later.

The task information 37 is information related to tasks. For example, the task information 37 is information that associates a task to be executed with processing target data processed by the task. An example of task information 37 will be described later.

The reception unit 11 receives various main signal messages from other edge servers 1 and the management server 2.

The distributed resource management unit 12 manages distributed resources. The distributed resource management unit 12 transmits a control message to each of the previous search resource determination unit 13, the periodical notification unit 14, the resource search unit 15, the response unit 16, the registration unit 17, and the task deployment place determination unit 20 to respective predetermined timings.

The previous search resource determination unit 13 refers to the scarcity level information 31 and the request frequency information 32, and determines a resource to be previously searched. For example, the previous search resource determination unit 13 converts the scarcity level for all resources transmitted from the management server 2 into the scarcity level information 31. For example, for each resource, the previous search resource determination unit 13 converts the ratio of the edge servers that do not satisfy the request resource amount to all edge servers into the average number of search hops requested to satisfy the request resource amount. For each resource, the previous search resource determination unit 13 sets the average number of search hops as the information related to the scarcity level to the scarcity level information 31. For each resource, the previous search resource determination unit 13 multiplies the scarcity level information 31 by the request frequency information 32, and selects a predetermined number of resources from the top of multiplied values. The previous search resource determination unit 13 determines whether or not the ranking of the selected resources has changed. When the ranking of the selected resources has changed, the previous search resource determination unit 13 transmits a previous search request including information related to the selected previous search resources to the edge servers 1 in the group. The “previous search request” described herein refers to a search request previously requested before the resource becomes depleted. For example, the previous search resource determination unit 13 determines the resource that tends to become depleted, and requests the edge servers 1 in the group to search the determined resource before depleted, at periodic notification. When the ranking of the selected resources has not changed, the previous search resource determination unit 13 has already transmitted the search request to the edge servers 1 in the group and thus, does not transmit the previous search request.

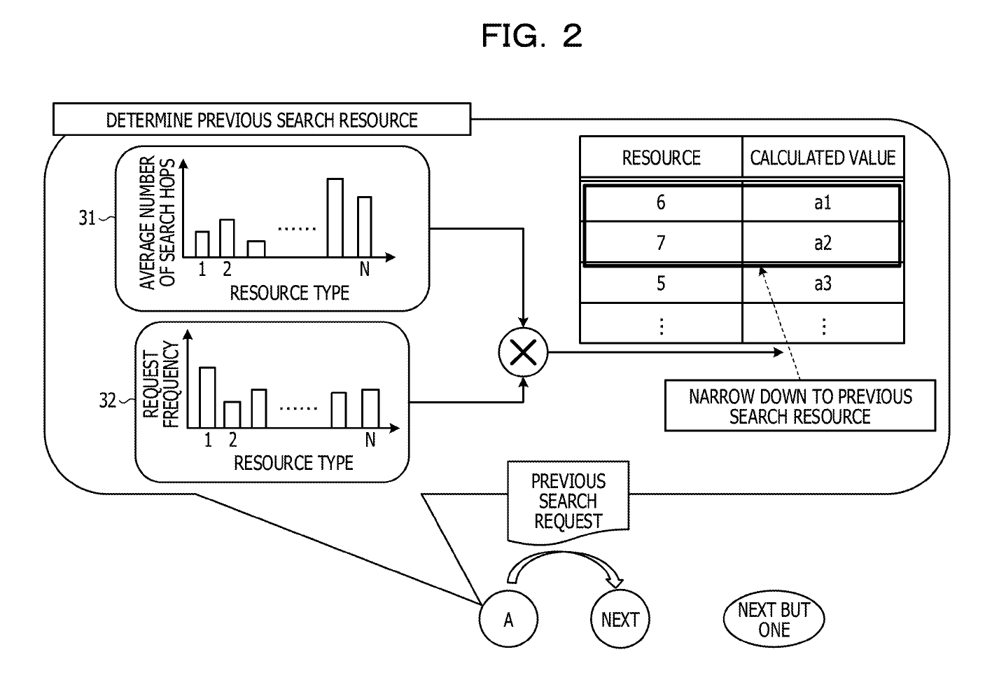

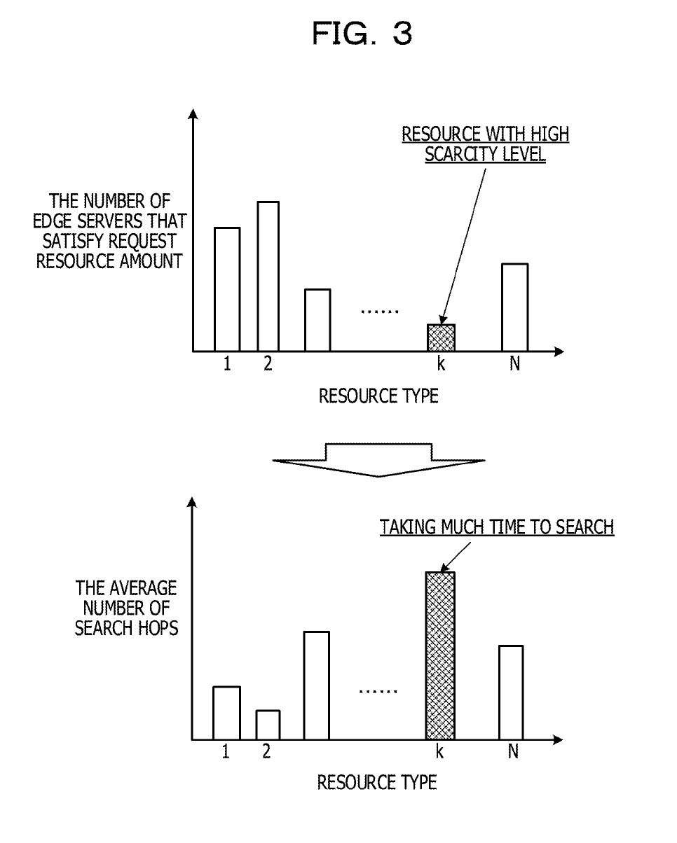

The determination of the previous search resource will be described below with reference to FIGS. 2 and 3. FIG. 2 is a diagram for describing the previous search resource determination according to Embodiment 1. It is assumed that the previous search resource determination unit 13 converts the scarcity level for all resources transmitted from the management server 2 into the scarcity level information 31. As illustrated in FIG. 2, the previous search resource determination unit 13 multiplies the scarcity level information 31 by the request frequency information 32 for each resource. Here, the scarcity level information 31 represents the average number of search hops for each resource. The average number of search hops is applied as information related to the scarcity level.

FIG. 3 is a diagram for describing relationship between the average number of search hops and the scarcity level. As illustrated in FIG. 3, the upper diagram illustrates the number of edge servers that satisfy the request resource amount for each resource. Here, as the number of edge servers that satisfy the request resource amount is smaller, the resource has a higher scarcity level. In other words, as the number of edge servers that do not satisfy the request resource amount request resource amount is larger, the resource has a higher scarcity level. For example, as the number of edge servers that do not satisfy the request resource amount is larger, the resource has a higher ratio of the edge servers that do not satisfy the request resource amount to all edge servers. That is, the resource has a high scarcity level. For example, the resource k has the highest scarcity level.

The lower diagram illustrates the average number of search hops requested to satisfy the request resource amount for each resource. As the scarcity level for the resource is higher, the average number of search hops becomes larger. It is due to that when the number of edge servers that satisfy the request resource amount is small, the average number of search hops requested to satisfy the request resource amount is small, taking much time for search. Similarly, as the scarcity level for the resource is lower, the average number of search hops is smaller. It is due to that when the number of edge servers that satisfy the request resource amount is large, the average number of search hops requested to satisfy the request resource amount is small, taking less time for search. Accordingly, the average number of search hops may be applied as the information related to the scarcity level.

Returning to FIG. 2, the previous search resource determination unit 13 narrows down to a predetermined number of previous search resources from the top of the multiplied values for each resource. The number of previous search resources may be determined depending on the size of a system. Here, the resource 6 and the resource 7 are narrowed down. After that, when the ranking of the narrowed resources has changed, the previous search resource determination unit 13 transmits the previous search request including information related to the narrowed previous search resources to the edge servers 1 in the group.

The periodical notification unit 14 periodically notifies a periodical notification message to the edge servers 1 in the group.

For example, the periodical notification unit 14 acquires resource values of the edge servers 1 in the group for the previous search resource from the resource value information 33 from a predetermined timing. The periodical notification unit 14 determines whether or not the edge server 1 that satisfies the request resource amount is present for the previous search resource. If the edge server 1 that satisfies the request resource amount is present, the periodical notification unit 14 acquires an address the edge server 1 from the address information 34. The periodical notification unit 14 transmits the periodical notification message including an address of the edge server 1 that satisfies the request resource amount for the previous search resource in addition to the resource value information related to all resources of the own edge server 1, to the edge servers 1 in the group. If the edge server 1 that satisfies the request resource amount is absent, the periodical notification unit 14 transmits the periodical notification message including only the resource value information related to all resources of the own edge server 1, to the edge servers 1 in the group.

If the periodical notification unit 14 receives a below-mentioned resource search request from the edge server 1 out of the group, the periodical notification unit 14 executes following processing. The periodical notification unit 14 acquires the resource value of the resource requested for resource search request from the resource value information 33, and transmits the periodical notification message including the own resource value information and result information to notification destinations that are the edge servers 1 out of the group. The “resource search request” refers to a resource request that requests the edge servers out of the group to search the resource depleted in the edge servers 1 in the group.

When the resource becomes depleted, the resource search unit 15 searches for the depleted resource from other edge servers 1 that satisfy the request resource amount. For example, the resource search unit 15 executes following processing for each resource. For the resource, the resource search unit 15 acquires resource values of the edge servers 1 in the group from the resource value information 33. For the resource, the resource search unit 15 sums the resource values acquired from the edge servers 1 in the group. If the sum exceeds a threshold value, the resource search unit 15 determines that the resource has depleted. The resource search unit 15 determines whether or not the edge server 1 that satisfies the request resource amount of this resource is present out of the group, based on the address information 34. If the edge server 1 that satisfies the request resource amount of this resource is present out of the group, the resource search unit 15 transmits the resource search request for this resource to the concerned edge server 1. If the edge server 1 that satisfies the request resource amount of this resource is absent out of the group, the resource search unit 15 transmits the resource search request for this resource to the edge server 1 having a small delay in the network, which is determined from topology information.

When receiving the resource search request, the response unit 16 responds to the request. For example, the response unit 16 acquires the resource value of the requested resource from the resource value information 33. If the own edge server 1 satisfies the request resource amount of the resource, the response unit 16 transmits a periodical notification request (periodical notification message) including the resource value of the requested resource to the registration unit 17. If the own edge server 1 does not satisfy the request resource amount of the resource, and other edge servers 1 satisfy the request resource amount of the resource, the response unit 16 transfers the resource search request to the other edge servers 1 concerned. If the own edge server 1 does not satisfy the request resource amount of the resource, and other edge servers 1 do not satisfy the request resource amount of the resource, the response unit 16 transfers a re-search request to a re-search request source.

When receiving the re-search request, the response unit 16 responds to the request. For example, the response unit 16 refers to the address information 34, and selects the second edge server 1 next to the edge server 1 to which the resource search request is transmitted most recently. The response unit 16 transmits the resource search request to the selected edge server 1.

When receiving the previous search request, the registration unit 17 registers information related to the resource included in the previous search request, in a column of the request resource in the address information 34. The registration unit 17 transfers the previous search request to the edge servers 1 in a previous search request range (TTL: Time To Live) according to the number of the edge servers 1 in the group. The previous search request range described herein may be represented as any number of hops. As an example, when two edge servers 1 are present in the group, the number of hops may be set to one. When six edge servers 1 are present in the group, the number of hops may be set to five. For example, using the previous search request range, the registration unit 17 transfers the previous search request to all edge servers 1 in the group.

When receiving the periodical notification message, the registration unit 17 registers the resource value of the resource of the edge server 1 that is the notification source in the periodical notification messages, in the resource value information 33. If the periodical notification message includes information out of the group, the registration unit 17 registers the address and the type of the previous search resource in the information out of the group, in the address information 34.

The data reception unit 18 receives data from an IoT (Internet of Things) device. The IoT device is, for example, portable communication equipment and however, may be any device connected via the Internet to enable monitoring and control.

The data and task management unit 19 manages data and tasks. For example, the data and task management unit 19 registers data received by the data reception unit 18 as the processing target data in the data information 36. The data and task management unit 19 associates a task to be executed with the processing target data to manage the task. The data and task management unit 19 manages the resource requested for each task together with the resource usage amount.

The task deployment place determination unit 20 determines the place where the task is deployed. For example, the task deployment place determination unit 20 acquires the resource usage amount of the resource requested by the task from the request resource information 35. The task deployment place determination unit 20 refers to the resource value information 33, and if the place (address) that satisfies the request for the resource is present, deploys the task at this place. If the place that satisfies the request for the resource is absent, the task deployment place determination unit 20 puts the task into a waiting queue.

The task execution unit 21 executes the task deployed by the task deployment place determination unit 20.

[Description of Periodical Notification]

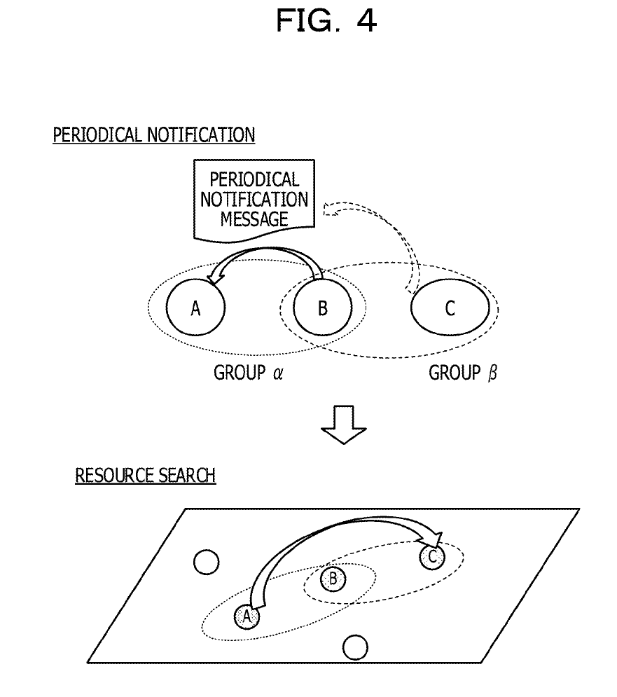

Here, periodical notification will be described with reference to FIG. 4. FIG. 4 is a diagram for describing the periodical notification according to Embodiment 1. A, B, and C each are the edge server 1. A and B belong to a group α. B and C belong to a group β. B belongs to a plurality of groups. FIG. 4 illustrates the periodical notification from B to A. It is assumed that B has received the previous search request including information related to the previous search resource from A belonging to the same group α.

As illustrated in FIG. 4, the periodical notification unit 14 acquires the resource value of the edge server C in the group β for the previous search resource at a time predetermined by a periodical timer. If the resource value of the edge server C satisfies the request resource amount, the periodical notification unit 14 transmits a periodical notification message including an address of the edge server C in addition to the resource value information related to all resources of the own edge server 1, to the edge server A in the group α. For example, the periodical notification unit 14 of the edge server B adds the information related to the edge server C out of the group (β) that satisfies the request resource amount of the resource with high scarcity level to the periodical notification message to be notified to the edge server A. The periodical notification unit 14 transmits the periodical notification message to the edge server A in the group α.

After that, if the resource with high scarcity level becomes depleted in the group α, the resource search unit 15 of the edge server A transmits the resource search request for this resource to the edge server C out of the group. Thereby, even if the resource becomes depleted in the group, the resource search unit 15 may request the resource search to the edge server 1 out of the group expected to satisfy the request resource amount of the resource, thereby reducing search time.

[Flow of Data Collection Processing]

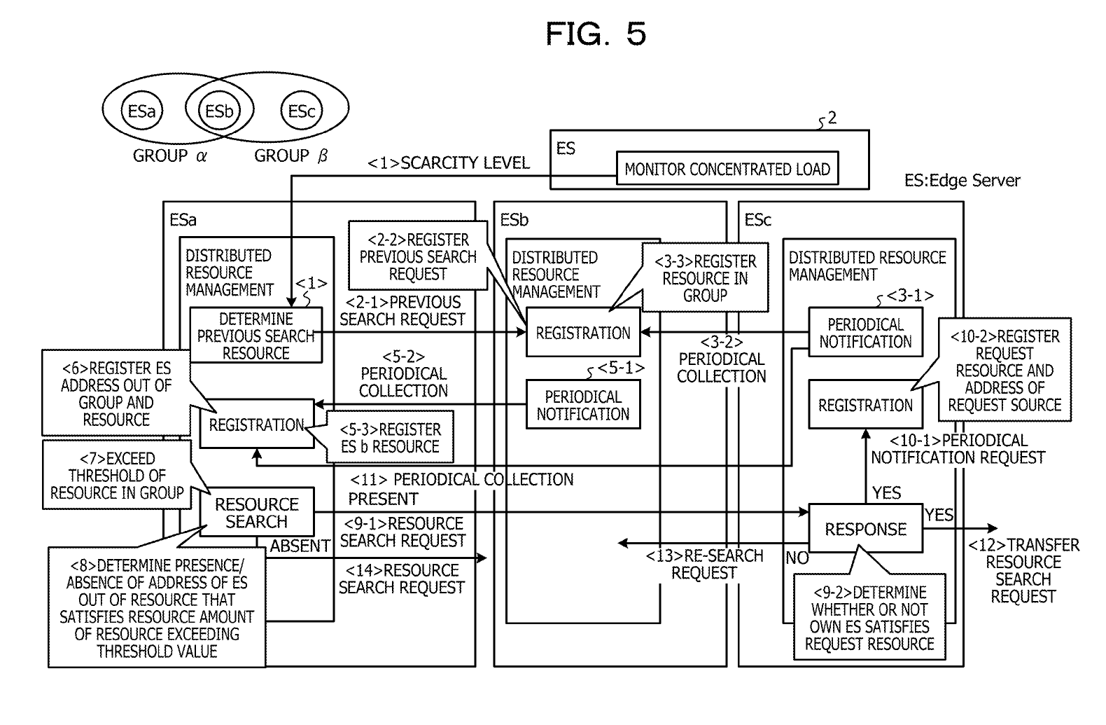

FIG. 5 is a diagram illustrating an example of a flow of data collection processing according to Embodiment 1. In FIG. 5, a, b, and c each are the edge server 1. a and b belong to a group α. b and c belong to a group β. b belongs to a plurality of groups.

In the edge server a, the reception unit 11 receives the scarcity level from the management server 2. The previous search resource determination unit 13 determines the previous search resource based on the scarcity level information 31 converted from the scarcity level and the request frequency information 32 (<1>). Then, the previous search resource determination unit 13 transmits the previous search request to the edge server b in the group α (<2-1>).

In the edge server b, when receiving the previous search request, the registration unit 17 registers information related to the resource included in the previous search request, in the address information 34 (<2-2>).

In the edge server c, the periodical notification unit 14 performs the periodical notification to the edge server b in the same group β at a time predetermined by a periodical timer (<3-1>, <3-2>). For example, the periodical notification unit 14 transmits a periodical notification message including the resource value information related to all resources of the own edge server 1 to the edge server b.

In the edge server b, when receiving the periodical notification message, the registration unit 17 registers the resource value information related to the edge server c that is the notification source in the group β (<3-3>). The periodical notification unit 14 performs periodical notification to the edge server a in the same group α at a time predetermined by a periodical timer (<5-1>, <5-2>). For example, if the edge server 1 that satisfies the request resource amount for the previous search resource is present, the periodical notification unit 14 transmits the periodical notification message including an address of the edge server 1 in addition to the resource value information related to all resources of the own edge server 1, to the edge server a. Here, if the edge server c is present as the edge server 1 that satisfies the request resource amount for the previous search resource, the periodical notification unit 14 transmits the periodical notification message further including the address of the edge server c and the type of the previous search resource to the edge server a.

In the edge server a, when receiving the periodical notification message, the registration unit 17 registers resource value information related to the edge server b that is the notification source in the group α (<5-3>). In addition, the registration unit 17 registers the address of the edge server c out of the group and the type of the resource in the address information 34 (<6>).

In the edge server a, it is assumed that the resource in the group α exceeds a threshold value (<7>). Then, the resource search unit 15 determines presence or absence of the address out of the group that satisfies the request resource amount of the resource exceeding the threshold value (<8>). If the address out of the group that satisfies the request resource amount of the resource exceeding the threshold value is present, the resource search unit 15 transmits the resource search request to the edge server c at the address (<9-1>).

In the edge server c, when receiving the resource search request, the response unit 16 determines whether or not the own edge server 1 satisfies the resource amount of the requested request resource (<9-2>). If the own edge server 1 satisfies the resource amount of the requested the request resource, the response unit 16 transmits the periodical notification request (periodical notification message) to the registration unit 17 (<10-1>). The registration unit 17 registers the resource amount of the requested request resource of the edge server c that is the notification source in the resource value information 33, and registers the request resource and an address of the request source in the address information 34 (<10-2>). After that, the periodical notification unit 14 transmits a periodical notification message including resource value information and result information of the own edge server 1 registered by the registration unit 17 to the edge server a out of the group indicated by the address of the request source requested for resource search request. If the own edge server 1 does not satisfy the resource amount of the requested request resource, and other edge servers 1 satisfy the resource amount of the requested request resource, the response unit 16 transfers the resource search request to the other edge servers 1 concerned (<12>). If the own edge server 1 does not satisfy the resource amount of the requested request resource, and other edge servers 1 do not satisfy the resource amount of the requested request resource, the response unit 16 transfers the re-search request to the edge server a that is the resource search request source (<13>).

In the edge server a, if an address out of the group that satisfies the request resource amount of the resource exceeding a threshold value is absent, the resource search unit 15 transmits the resource search request to the edge server 1 having a small delay in the network acquired from the topology information (<14>).

[Sequence of Data Collection Processing]

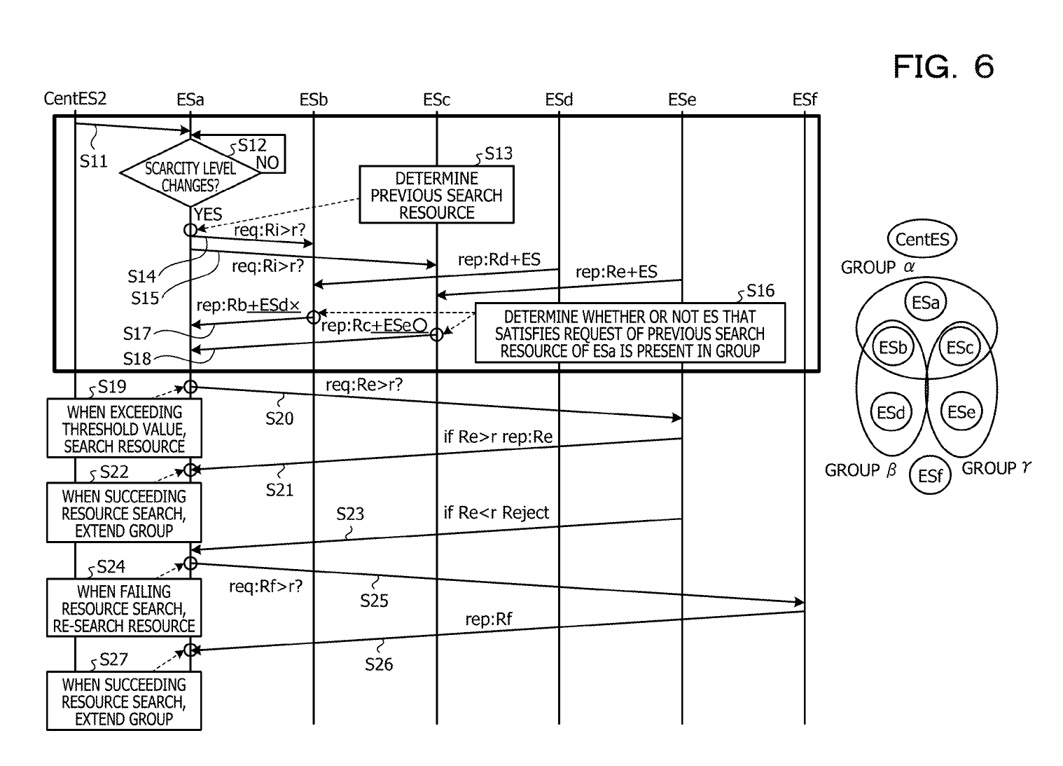

FIG. 6 is a diagram illustrating an example of a sequence of data collection processing according to Embodiment 1. In FIG. 6, a, b, c, d, e, and f each are the edge server 1. a, b, and c belong to a group α. b and d belong to a group β. c and e belong to a group γ. b and c belong to a plurality of groups. In FIG. 6, the management server 2 is described as CentES.

When receiving the scarcity level from the management server 2 (S11), the edge server a determines whether or not the scarcity level has changed (S12). If the scarcity level does has not changed (S12; No), the edge server a does not determine the previous search resource. On the contrary, if the scarcity level has changed (S12; Yes), the edge server a determines the previous search resource (S13).

The edge server a transmits the previous search request including information related to the determined previous search resource to the edge servers b, c in the group α (S14, S15).

It is assumed as follows. The edge server b receives resource value information related to all resources of the edge server d from the edge server d in the same group β. The resource value information received from the edge server d does not satisfy the request of the previous search resource. The edge server c receives resource value information related to all resources of the edge server e from the edge server e in the same group γ. The resource value information received from the edge server e satisfies the request of the previous search resource.

Under such situation, the edge server b determines whether or not the edge server that satisfies the request of the previous search resource transmitted from the edge server a is present in the group β (S16). Since the edge server that satisfies the request of the previous search resource is not present in the group β, the edge server b transmits a periodical notification message including only resource value information related to all resources of the edge server b to the edge server a (S17).

The edge server c determines whether or not the edge server that satisfies the request of the previous search resource transmitted from the edge server a is present in the group γ (S16). Since the edge server that satisfies the request of the previous search resource is present in the group γ, the edge server c transmits a periodical notification message including an address of the edge server e that satisfies the request of the previous search resource in addition to the resource value information related to all resources of the edge server c, to the edge server a (S18).

After that, when the resource value of the previous search resource in the group α exceeds a threshold value, the edge server a transmits the resource search request expected to satisfy the request of the previous search resource to the edge server e (S19, S20). Thereby, even if the resource becomes depleted in the group α, the edge server a may request the resource search to the edge server e out of the group, which is expected to satisfy the request resource amount of the resource, to reduce search time.

When succeeding the resource search in the edge server e, the edge server a may add the edge server e to the group α to extend the group a (S21, S22). Thereby, after the extension of the group α, even if the edge server a does not request the resource search out of the group, the edge server a may directly search the resource in the group to reduce search time.

When failing the resource search for the edge server e, the edge server a transmits the re-search request of the previous search resource to the edge server f having a small delay in the network acquired from topology information (S23 to S25).

When succeeding the resource search for the edge server f, the edge server a may add the edge server f to the group α to extend the group α (S26, S27). Thereby, after the extension of the group α, even if the edge server a does not request the resource search out of the group, the edge server a may directly search the resource in the group, to reduce search time.

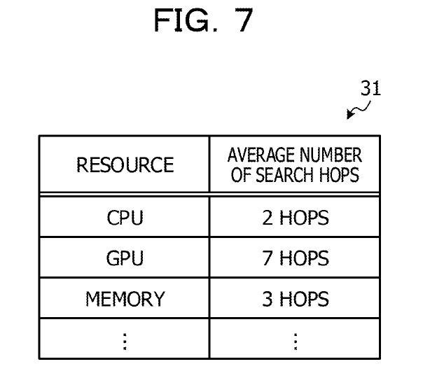

FIGS. 7 to 13 each are tables illustrating examples of various information stored in the storage unit 30.

[Example of Scarcity Level Information]

FIG. 7 is a table illustrating an example of scarcity level information. As illustrated in FIG. 7, the scarcity level information 31 is information that associates the resource with the average number of search hops. The resource is a target resource. The average number of search hops is the average number of hops requested to satisfy the request resource amount of the resource. The average number of search hops corresponds to the scarcity level. As an example, when the resource is “CPU”, the average number of search hops is set to “two hops”. When the resource is “GPU”, the average number of search hops is set to “seven hops”. In the example illustrated in FIG. 7, the “GPU” is the resource with high scarcity level.

[Example of Request Frequency Information]

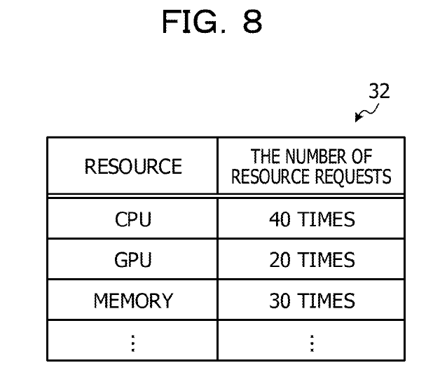

FIG. 8 is a table illustrating an example of request frequency information. As illustrated in FIG. 8, the request frequency information 32 is information that associates the resource with the number of resource requests. The resource is a target resource. The number of resource requests is the number of requests made to the resource within a certain time. As an example, when the resource is “CPU”, “40” is set to the number of resource requests. When the resource is “GPU”, “20” is set to the number of resource requests.

[Example of Resource Value Information]

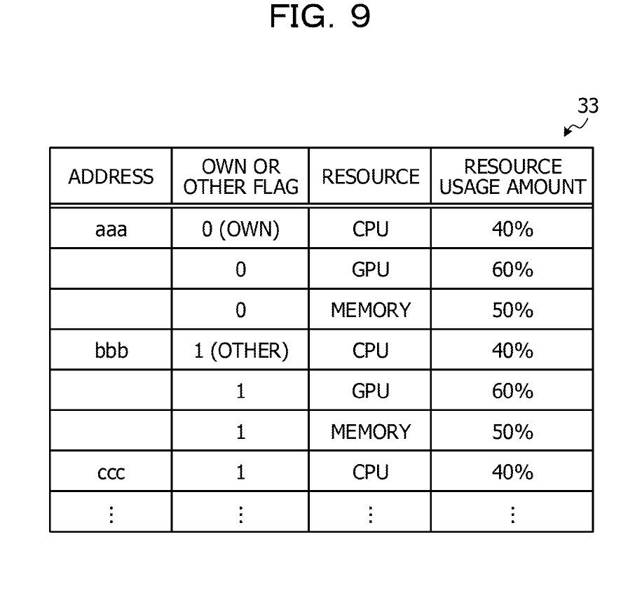

FIG. 9 is a table illustrating an example of resource value information. As illustrated in FIG. 9, the resource value information 33 is information that associates address, own or other flag, resource, and resource usage amount with one another. The address is an address of the edge server 1. As an example, the address is an IP (Internet Protocol) address. The own or other flag is a flag for determining whether the edge server 1 is the own edge server 1 or other edge server 1. As an example, when the edge server 1 is the own edge server 1, “0” is set. When the edge server 1 is other edge server 1, “1” is set. The resource is a target resource. The resource usage amount is a usage amount o the resource. As an example, when the address is “aaa”, “0” is set to the own or other flag, “CPU” is set to the resource, and “40%” is set to the resource usage amount. When the address is “aaa”, “0” is set to the own or other flag, “GPU” is set to the resource, “60%” is set to the resource usage amount. When the address is “bbb”, “1” is set to the own or other flag, “CPU” is set to the resource, “40%” is set to the resource usage amount. When the address is “bbb”, “1” is set to the own or other flag, “GPU” is set to the resource, and “60%” is set to the resource usage amount.

[Example of Address Information]

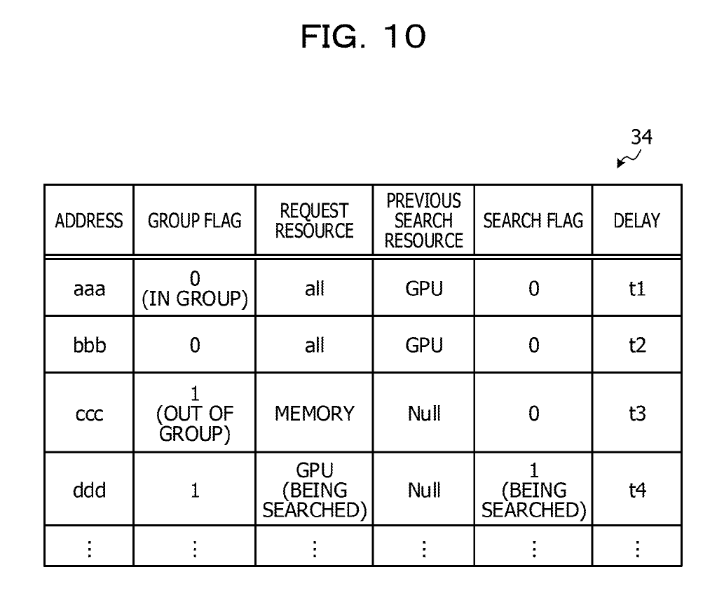

FIG. 10 is a table illustrating an example of address information. As illustrated in FIG. 10, the address information 34 is information that associate address, group flag, request resource, previous search resource, search flag, and delay. The address is an address of the edge server 1. The address corresponds to the address in the resource value information 33. The group flag is a flag for determining whether or not the edge server is in the group. As an example, when the edge server is in the group, “0” is set. When the edge server is out of the group, “1” is set. The request resource is a resource notified by periodical notification. As an example, when all resources are notified, “all” is set. When the previous search resource is notified, the type of the resource is set. The previous search resource is a resource requested by previous search. The search flag is a flag for determining whether or not the edge server is being searched by the resource search request. As an example, when the edge server is being searched, “1” is set. When the edge server is not being searched, “0” is set. The delay is a delay time between the own edge server and the edge server 1 indicated by the address in the network. The resource search unit 15 sets “1” (being searched) to the search flag.

As an example, when the address is “aaa”, “0” is set to the group flag, “all” is set to the request resource, “GPU” is set to the previous search resource, “0” is set to the search flag, and “t1” is set to the delay. When the address is “ccc”, “1” is set to the group flag, “memory” is set to the request resource, “Null” is set to the previous search resource, “0” is set to the search flag, and “t3” is set to the delay. When the address is “ddd”, “1” is set to the group flag, “GPU” is set to the request resource, “Null” is set to the previous search resource, “1” is set to the search flag, and “t4” is set to the delay.

[Example of Request Resource Information]

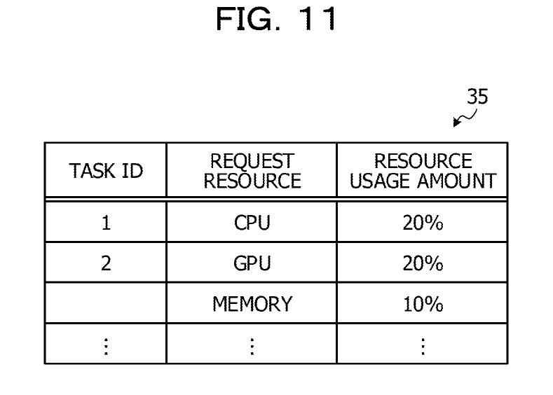

FIG. 11 is a table illustrating an example of request resource information. As illustrated in FIG. 11, the request resource information 35 is information that associates task ID (IDentifier), request resource, and resource usage amount with one another. The task ID is an identifier for identifying the task. The request resource is a resource requested by the task. The resource usage amount is a usage amount with which the resource uses the request resource. As an example, when the task ID is “1”, “CPU” is set to the request resource, and “20%” is set to the resource usage amount.

[Example of Data Information]

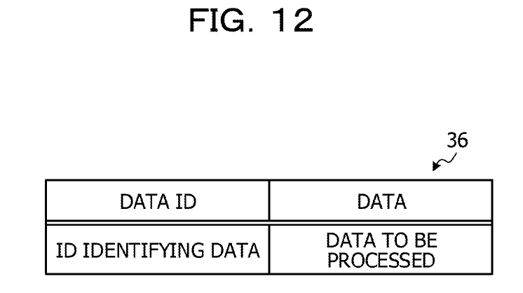

FIG. 12 is a table illustrating an example of data information. As illustrated in FIG. 12, the data information 36 is information that associates data ID with data. The data ID is an identifier for identifying data. The data is data to be processed.

[Example of Task Information]

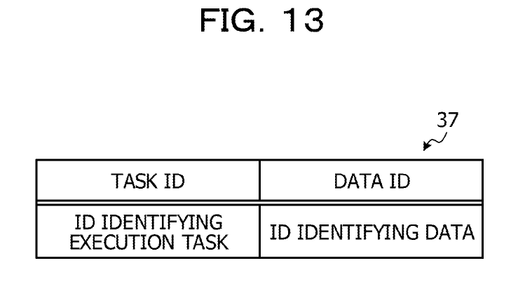

FIG. 13 is a table illustrating an example of task information. As illustrated in FIG. 13, the task information 37 is information that associates task ID with data ID. The task ID is an identifier for identifying data to be executed. The data ID is an ID for identifying data. The task ID corresponds to the task ID in the request resource information 35. The data ID corresponds to the data ID in the data information 36.

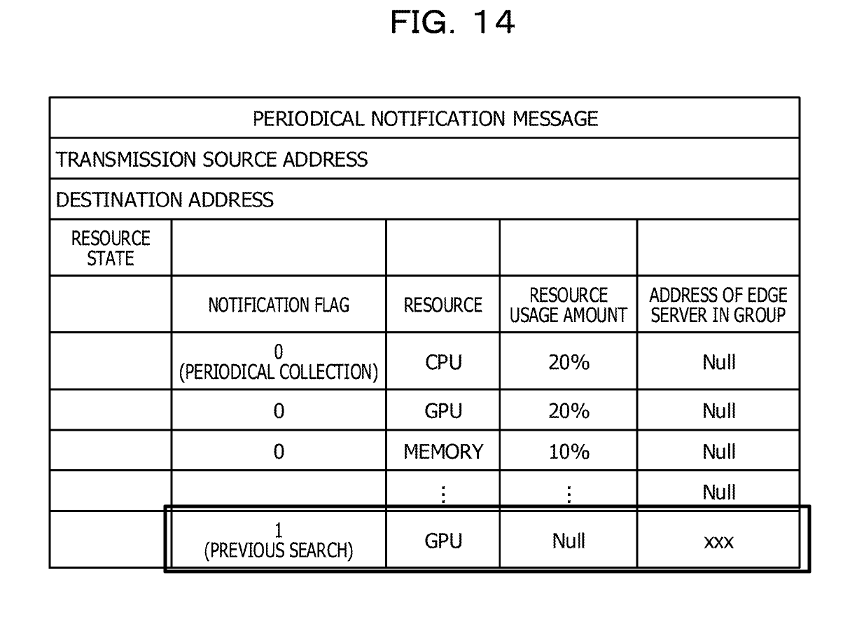

FIGS. 14 to 16 are tables illustrating examples of various messages.

[Example of Periodical Notification]

An example of the periodical notification message transmitted by the periodical notification unit 14 will be described with reference to FIG. 14. FIG. 14 is a table illustrating an example of periodical notification. As illustrated in FIG. 14, the periodical notification message is a message that associates notification flag, resource, resource usage amount, and address of edge server in group with one another. The notification flag is a flag for determining whether it is periodical collection or previous search. As an example, when it is periodical collection, “0” is set. When it is previous search, “1” is set. The resource is the type of collected resource. The resource usage amount is a usage amount of the resource. The address of edge server in group is an address of other edge server 1 in the same group as the own edge server 1 that transmits the periodical notification message. As an example, in the case of the own edge server 1, “Null” is set. In the case of other edge server 1, the address of the edge server 1 is set. For example, other edge server 1 that satisfies the request resource amount for the previous search resource is present in the group, the periodical notification unit 14 transmits a periodical notification message including the address of the other edge server 1 and the type of the previous search resource in addition to the resource value information related to all resources of the own edge server 1.

As an example, when the notification flag is “0”, “CPU” is set to the resource, “20%” is set to the resource usage amount, and “Null” is set to the address of edge server in group. When the notification flag is “1”, “GPU” is set to the resource, “Null” is set to the resource usage amount, and “xxx” is set to the address of edge server in group.

[Example of Resource Search Request]

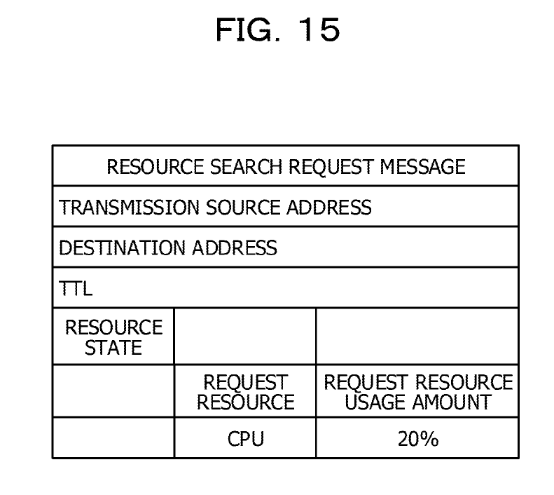

An example of the resource search request message transmitted by the resource search unit 15 is described with reference to FIG. 15. FIG. 15 is a table illustrating an example of the resource search request. As illustrated in FIG. 15, the resource search request message is a message that associates the request resource with the request resource usage amount. The request resource is a resource requested when the resource becomes depleted. The request resource usage amount is the resource usage amount requested by the request resource. As an example, when the request resource is “CPU”, “20%” is set to the request resource usage amount.

[Example of Previous Search Request]

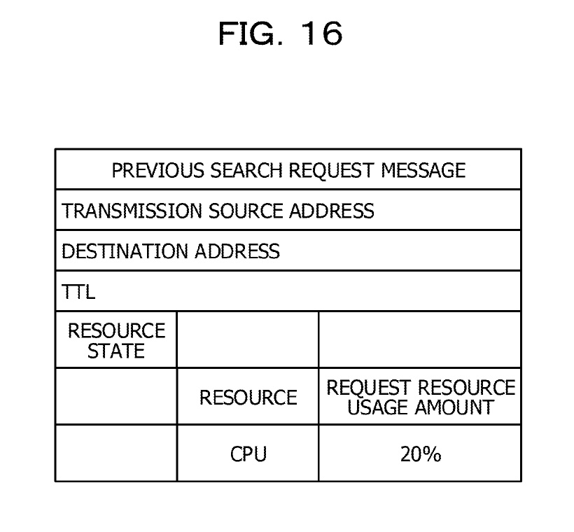

An example of the previous search request message transmitted by the previous search resource determination unit 13 will be described below with reference to FIG. 16. FIG. 16 is a table illustrating an example of the previous search request. As illustrated in FIG. 16, the previous search request message is a message that associates the resource with the request resource usage amount. The resource is the previous search resource. The request resource usage amount is a resource usage amount requested by the previous search resource. As an example, when the resource is “CPU”, “20%” is set to the request resource usage amount.

[Example of Re-Search Request]

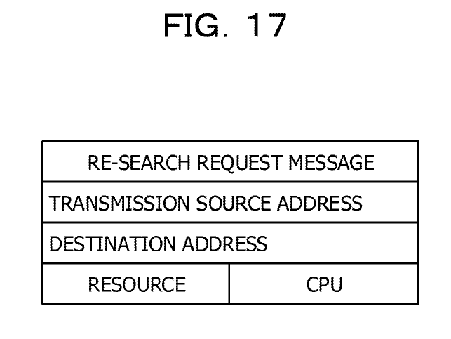

An example of the re-search request message transmitted by the response unit 16 is described below with reference to FIG. 17. FIG. 17 is a table illustrating an example of the re-search request. As illustrated in FIG. 17, the re-search request message includes the type of the resource. The resource is a resource to be searched again. As an example, “CPU” is set to as the resource.

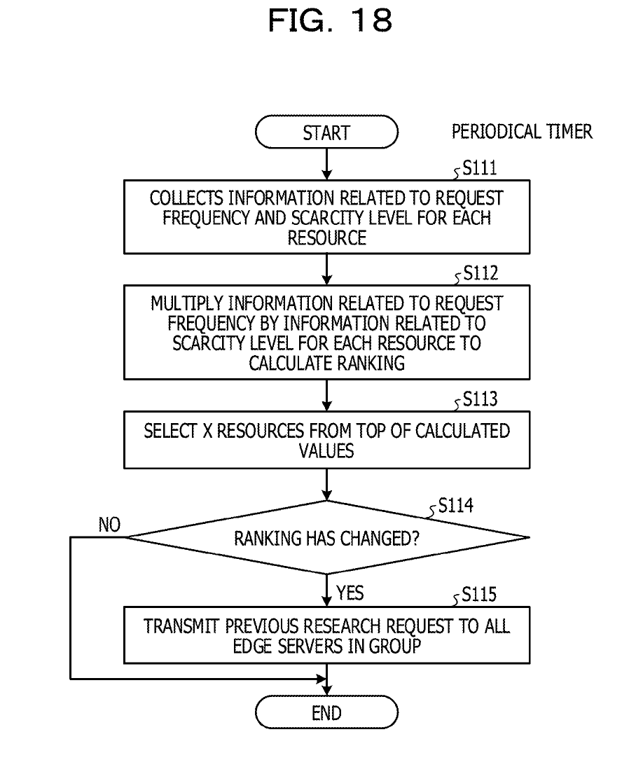

FIGS. 18 to 23 are flow charts illustrating examples of various processing.

[Flow Chart of Previous Search Resource Determination Processing]

FIG. 18 is a flow chart illustrating an example of processing of the previous search resource determination unit according to Embodiment 1. It is assumed that the previous search resource determination unit 13 converts the scarcity level of all resources received from the management server 2 into the scarcity level information 31 that is information related to the scarcity level.

As illustrated in FIG. 18, the previous search resource determination unit 13 collects information related to the request frequency and the scarcity level for each resource at a timing predetermined by a periodical timer (S111). For example, the previous search resource determination unit 13 collects the number of resource requests for each resource from the request frequency information 32. The previous search resource determination unit 13 collects the average number of search hops for each resource from the scarcity level information 31.

The previous search resource determination unit 13 multiplies information related to the request frequency by information related to the scarcity level for each resource to calculate the ranking (S112). For example, the previous search resource determination unit 13 multiplies the number of resource requests by the average number of search hops for each resource, and ranks the resources based on the calculated multiplied values.

The previous search resource determination unit 13 selects X resources from the top of the calculated values (S113). X may be a predetermined number of units.

The previous search resource determination unit 13 determines whether or not the ranking of the selected resources has changed (S114). If the previous search resource determination unit 13 determines that the ranking has not changed (S114; No), the previous search resource determination unit 13 finishes previous search resource determination processing.

On the contrary, if the previous search resource determination unit 13 determines that the ranking has changed (S114; Yes), the previous search resource determination unit 13 transmits the previous search request to all edge servers 1 in the group (S115). For example, the previous search resource determination unit 13 refers to the address information 34, sets the selected resources as previous search resources, and transmits the previous search request including information related to the previous search resource to the edge servers 1 indicated by addresses with the group flag in the group. The previous search resource determination unit 13 finishes the previous search resource determination processing.

[Flow Chart of Periodical Notification Processing]

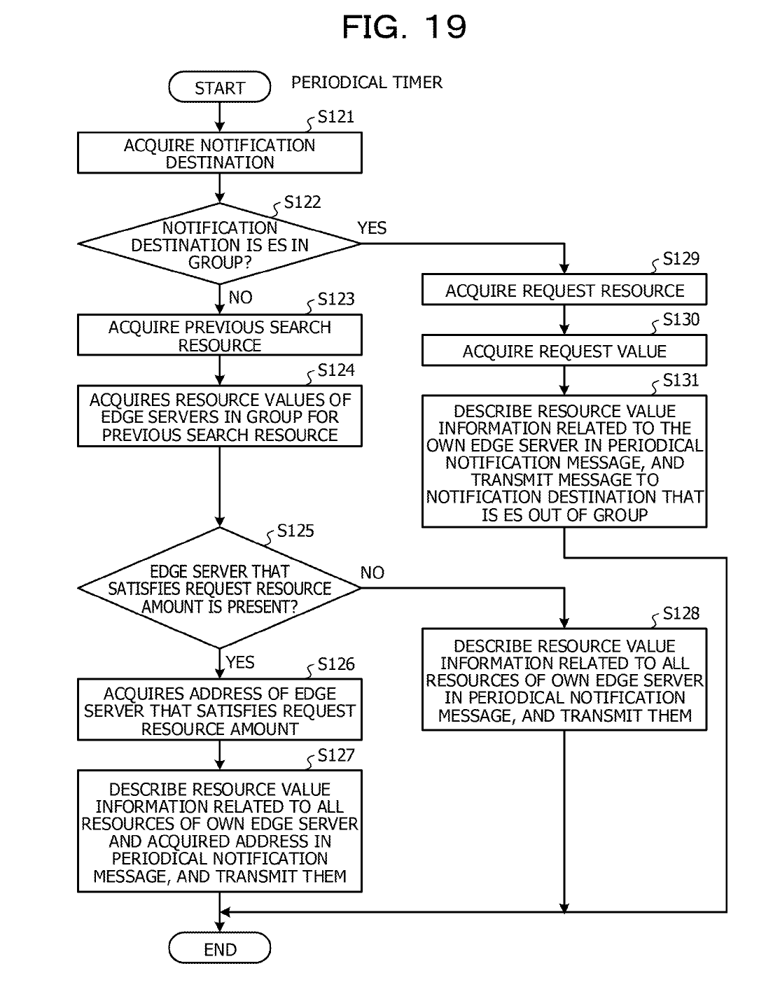

FIG. 19 is a flow chart illustrating an example of processing of the periodical notification unit according to Embodiment 1.

As illustrated in FIG. 19, the periodical notification unit 14 acquires a notification destination from the address information 34 at a timing predetermined by a periodical timer (S121). For example, the periodical notification unit 14 acquires addresses other than the address of the own edge server 1, as the notification destination, from the address information 34.

The periodical notification unit 14 determines whether or not the notification destination is the ES in the group (S122). If the periodical notification unit 14 determines that the notification destination is the edge server (ES) 1 in the group (S122; Yes), the periodical notification unit 14 acquires the previous search resource for the notification destination in the group from the address information 34 (S123). The periodical notification unit 14 acquires the resource values of the edge servers 1 in the group for the previous search resource from the resource value information 33 (S124).

The periodical notification unit 14 determines whether or not the edge server 1 that satisfies the request resource amount is present (S125). If the periodical notification unit 14 determines that the edge server 1 that satisfies the request resource amount is present (S125; Yes), the periodical notification unit 14 acquires an address of the edge server 1 that satisfies the request resource amount from the address information 34 (S126).

The periodical notification unit 14 describes the resource value information related to all resources of the own edge server 1 and the acquired address in the periodical notification message, and transmits the message to the edge server 1 that is the notification destination (S127). The periodical notification unit 14 finishes periodical notification processing.

On the contrary, if the periodical notification unit 14 determines that the edge server 1 that satisfies the request resource amount is absent (S125; No), the periodical notification unit 14 executes following processing. The periodical notification unit 14 acquires resource value information related to all resources of the own edge server 1 from the resource value information 33. The periodical notification unit 14 describes the resource value information related to all resources of the own edge server 1 in the periodical notification message, and transmits the message to the edge server 1 that is the notification destination (S128). The periodical notification unit 14 finishes the periodical notification processing.

In S122, the periodical notification unit 14 determines that the notification destination is not the edge server (ES) 1 in the group (S122; No), the periodical notification unit 14 acquires the request resource for an address of the notification destination from the address information 34 (S129). That is, the resource search unit 15 of the own edge server 1 receives the resource search request, and satisfies the request resource amount of the request resource. As an example of the notification destination, in FIG. 10, when the address is “ccc”, “memory” is acquired as the request resource.

The periodical notification unit 14 acquires the resource value of the request resource of the own edge server 1 from the resource value information 33 (S130). The periodical notification unit 14 describes resource value information related to the own edge server 1 in the periodical notification message, and transmits the message to the notification destination that is the edge servers 1 out of the group (S131). The periodical notification unit 14 finishes the periodical notification processing.

[Flow Chart of Resource Search Processing]

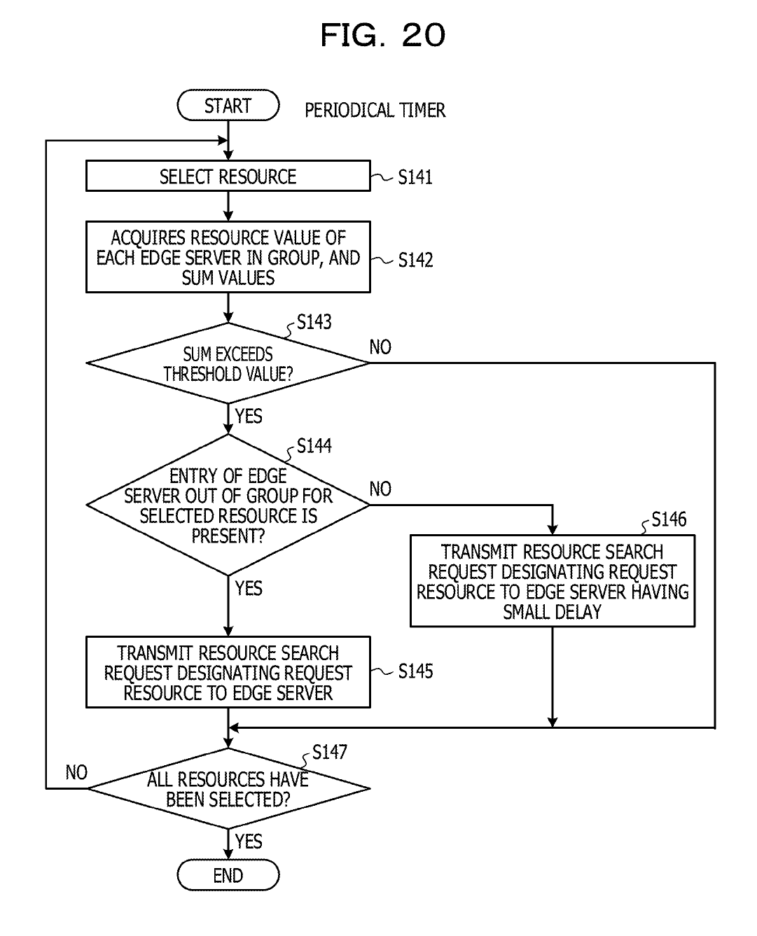

FIG. 20 is a flow chart illustrating an example of processing of the resource search unit according to Embodiment 1.

As illustrated in FIG. 20, the resource search unit 15 selects a resource at a timing predetermined by a periodical timer (S141). The resource search unit 15 acquires the resource value of each edge server 1 in the group for the selected resource from the resource value information 33, and sums the values (S142).

The resource search unit 15 determines whether or not the sum exceeds a threshold value (S143). If the resource search unit 15 determines that the sum does not exceed the threshold value (S143; No), the resource search unit 15 does not search the resource. The resource search unit 15 proceeds to S147.

On the contrary, if the resource search unit 15 determines that the sum exceeds the threshold value (S143; Yes), the resource search unit 15 determines whether or not an entry of the edge server 1 out of the group for the selected resource is present based on the address information 34 (S144). If the resource search unit 15 determines that the entry of the edge server 1 out of the group for the selected resource is present (S144; Yes), the resource search unit 15 transmits the resource search request designating the request resource to the edge server 1 concerned (S145). The resource search unit 15 proceeds to S147.

On the contrary, if the resource search unit 15 determines that the entry of the edge server 1 out of the group for the selected resource is absent (S144; No), the resource search unit 15 selects the edge server 1 having a small delay from the address information 34, and transmits the resource search request designating the request resource to the selected edge server 1 (S146). At this time, the resource search unit 15 sets “1”, which represents that the resource is being searched, to the search flag corresponding to the address of the selected edge server 1 in the address information 34, and sets the request resource in the request resource column. The resource search unit 15 proceeds to S147.

In S147, the resource search unit 15 determines whether or not all resources have been selected (S147). If the resource search unit 15 determines that all resources have not been selected (S147; No), the resource search unit 15 proceeds to S141 to select a next resource.

On the contrary, if the resource search unit 15 determines that all resources have been selected (S147; Yes), the resource search unit 15 finishes resource search processing.

[Flow Chart of Response Processing]

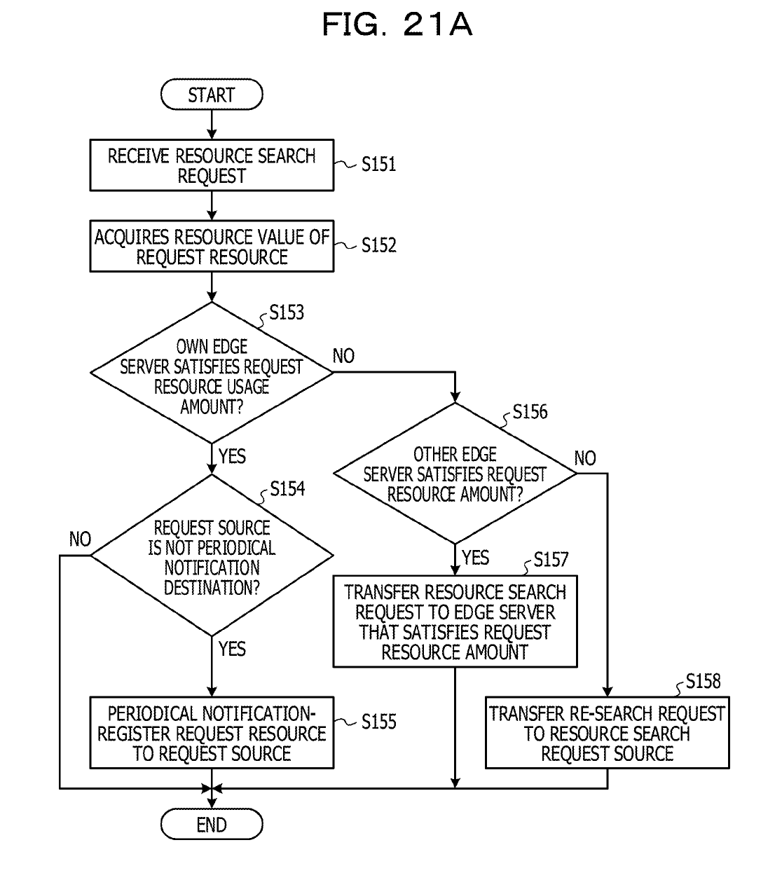

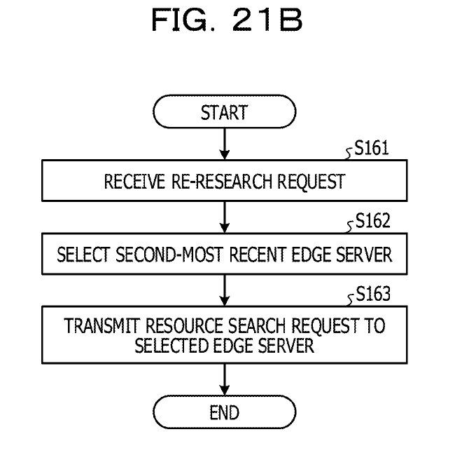

FIGS. 21A and 21B are flow charts illustrating examples of processing of the response unit according to Embodiment 1. FIG. 21A is a flow chart illustrating the example of the processing of the response unit in the case where the resource search request is received. FIG. 21B is a flow chart illustrating the example of the processing of the response unit in the case where the re-search request is received.

As illustrated in FIG. 21A, when receiving resource search request (S151), the response unit 16 acquires the resource value of the request resource in the resource search request from the resource value information 33 (S152).

The response unit 16 determines whether or not the own edge server 1 satisfies the request resource usage amount of the request resource (S153). If the response unit 16 determines that the own edge server 1 satisfies the request resource usage amount of the request resource (S153; Yes), the response unit 16 determines whether or not the request source is not a periodical notification destination (S154). If the response unit 16 determines that request source is the periodical notification destination (S154; No), the response unit 16 finishes response processing.

On the contrary, if the response unit 16 determines that request source is not the periodical notification destination (S154; Yes), the response unit 16 periodical notification-registers the request resource to the request source (S155). For example, the response unit 16 transmits the periodical notification request including the resource value of the request resource to the registration unit 17. Then, the response unit 16 finishes the response processing.

In S153, if the response unit 16 determines that the own edge server 1 does not satisfy the request resource usage amount of the request resource (S153; No), the response unit 16 determines whether or not other edge server 1 satisfies the request resource amount of the request resource based on the resource value information 33 (S156). If the response unit 16 determines that other edge server 1 satisfies the request resource amount of the request resource (S156; Yes), the response unit 16 transfers the resource search request to the edge server 1 that satisfies the request resource amount (S157). Then, the response unit 16 finishes the response processing.

On the contrary, if the response unit 16 determines that other edge servers 1 do not satisfy the request resource amount of the request resource (S156; No), the response unit 16 transfers the re-search request to the resource search request source (S158). Then, the response unit 16 finishes the response processing.

As illustrated in FIG. 21B, when receiving the re-search request (S161), the response unit 16 selects the second edge server 1 next to the edge server 1 to which the resource search request is transmitted most recently, from the address information 34 (S162).

The response unit 16 transmits the resource search request to the selected edge server 1 (S163). Then, the response unit 16 finishes the response processing.

[Flow Chart of Registration Processing]

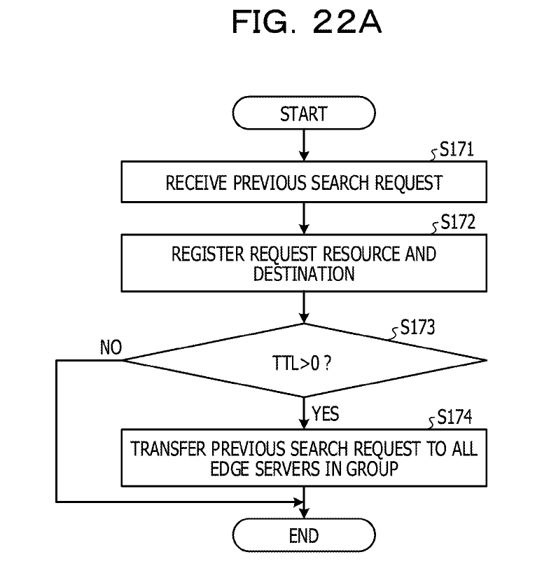

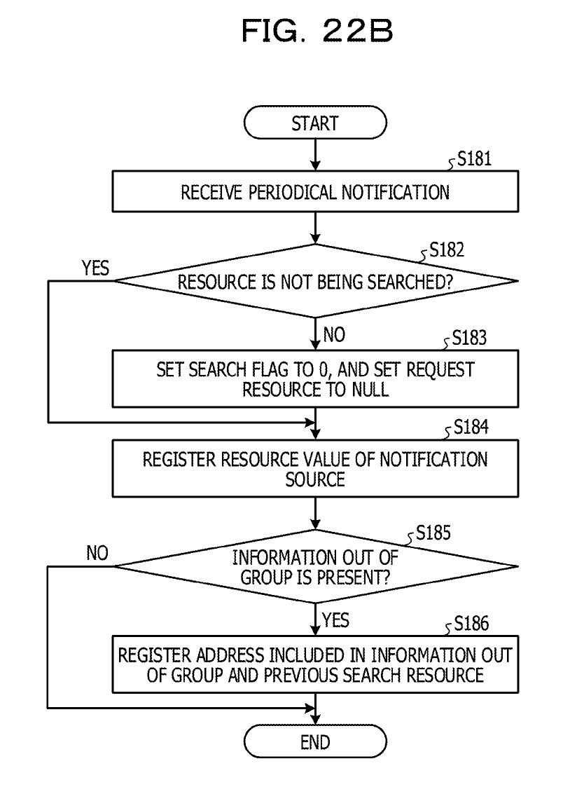

FIGS. 22A and 22B are flow charts illustrating examples of processing of the registration unit according to Embodiment 1. FIG. 22A is a flow chart illustrating the example of the processing of the registration unit in the case where the previous search request is received. FIG. 22B is a flow chart illustrating the example of the processing of the registration unit in the case where the periodical notification is received.

As illustrated in FIG. 22A, when receiving the previous search request (S171), the registration unit 17 registers the request resource and a destination that is the request source in the previous search request, in the address information 34 (S172).

The registration unit 17 determines whether or not the previous search request range (TTL) is larger than 0 (S173). If the registration unit 17 determines that TTL is larger than 0 (S173; Yes), the registration unit 17 transmits the previous search request to all edge servers 1 in the group (S174). The registration unit 17 finished registration processing.

On the contrary, if registration unit 17 determines that the TTL is not larger than 0 (S173; No), the registration unit 17 finishes the registration processing without transferring the previous search request.

As illustrated in FIG. 22B, when receiving the periodical notification (S181), the registration unit 17 determines whether or not the resource is being searched from the address information 34 (S182). If registration unit 17 determines that the resource is not being searched (S182; Yes), the registration unit 17 proceeds to S184.

On the contrary, if the registration unit 17 determines that the resource is being searched (S182; No), the registration unit 17 sets a search flag to “0” indicating that the resource is not being searched, for the entry searched in the address information 34, and sets the request resource to Null (S183). The registration unit 17 proceeds to S184.

In S184, the registration unit 17 registers the resource value of the notification source of the periodical notification in the periodical notification message, in the resource value information 33 (S184). The registration unit 17 determines whether or not information out of group is present in the periodical notification message (S185). If the registration unit 17 determines that the information out of group is present (S185; Yes), the registration unit 17 registers the address included in the information out of group and the type of the previous search resource in the address information 34 (S186). Then, the registration unit 17 finishes the registration processing.

On the contrary, if the registration unit 17 determines that the information out of group is absent (S185; No), the registration unit 17 finishes the registration processing.

[Flow Chart of Task Scheduler Processing]

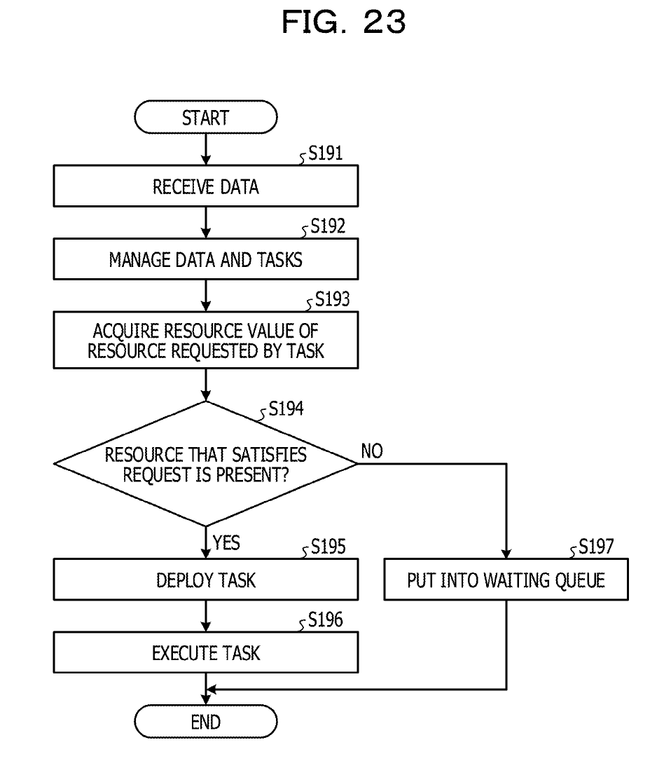

FIG. 23 is a flow chart illustrating an example of task scheduler processing according to Embodiment 1.

As illustrated in FIG. 23, the data reception unit 18 receives data from an IoT device (S191). The data and task management unit 19 manages the received data and the task to be executed (S192).

The task deployment place determination unit 20 acquires the resource value of the resource requested by the task to be executed, from the resource value information 33 (S193).

The task deployment place determination unit 20 determines whether or not the resource that satisfies the request is present (S194). If the task deployment place determination unit 20 determines that the resource that satisfies the request is present (S194; Yes), the task deployment place determination unit 20 deploys the task to be executed at the address of the edge server 1 having the resource that satisfies the request (S195). The task execution unit 21 executes the task in the deployed edge server 1 (S196). The task execution unit 21 finishes task scheduler processing.

On the contrary, if the task deployment place determination unit 20 determines that the resource that satisfies the request is absent (S194; No), the task deployment place determination unit 20 puts the task to be executed into a waiting queue (S197). The task deployment place determination unit 20 finishes the task scheduler processing.

A new edge server 1 may participate in the distributed processing system 9. In this case, for example, the new edge server 1 may transmit a participation request to the management server 2. For example, the management server 2 that accepted the participation request notifies addresses of the edge server 1 having a small delay in the network and the new edge server 1 to the new edge server 1. The new edge server 1 determines the edge servers 1 at the notified addresses as a group, and request periodical notification to the edge servers 1 in the group. The management server 2 informs the edge servers 1 in the group that the new edge server 1 is included in the group consisting of the new edge server 1 and the edge server 1 having a small delay in the network. The edge servers 1 in the group requests periodical notification to the new edge server 1. The management server 2 informs a change in the entire system after the participation of the new edge server 1, to the edge servers 1 in the system. Thereby, the distributed processing system 9 enables smooth participation of the new edge server 1.

The management server 2 according to Embodiment 1 may be offered in the form of cloud.

According to Embodiment 1, the management server 2 monitors the load of the plurality of edge servers 1 in the distributed processing system 9. However, in place of the management server 2, each edge server 1 may autonomously monitor the load in a distributed manner.

### Effects of Embodiment 1

According to Embodiment 1, the first edge server 1 narrows down the plurality of resources to be collected to a predetermined resource that takes much time to search the information processing apparatus that satisfies the request resource amount. The first edge server 1 notifies information related to the narrowed predetermined resource to the second edge server 1 belonging to the first group of the first edge server 1. The second edge server 1 periodically collects the resource amounts of the plurality of resources to be collected from the edge servers 1 belonging to a second group other than the first group, to which the second edge server 1 belongs. The second edge server 1 acquires the resource amount of the predetermined resource from the edge servers 1 belonging to the second group at a predetermined timing, based on the collected information. If the resource amount of a predetermined resource satisfies a predefined resource amount, the second edge server 1 adds apparatus information related to the edge server 1 to the resource amounts of the plurality of resources to be collected in the second edge server 1, and periodically notifies the information to the first edge server 1. With such configuration, even if the predetermined resource becomes depleted in the first group, the first edge server 1 may reduce the time requested to search the edge server 1 that satisfies the request resource amount of the predetermined resource. The first edge server 1 may suppress the number of messages requested for searching the predetermined resource.

In Embodiment 1, the resource amount of the predetermined resource of all edge servers 1 in the first group is satisfied, the first edge server 1 executes following processing. The first edge server 1 searches the predetermined resource for the edge servers 1 included in the second group, which is expected to satisfy the resource amount of the predetermined resource. With such configuration, using resource information related to the group (second group) to which the own edge server does not belong, the first edge server 1 searches the resource that does not satisfy the resource amount in the group. Thereby, the first edge server 1 may search the predetermined resource once to suppress the number of messages.

In Embodiment 1, using the number of the edge servers 1 that do not satisfy the request resource amount for each type of the resource, the first edge server 1 calculates the average number of hops requested to search the edge server 1 that satisfies the request resource amount. The first edge server 1 acquires the request frequency of the resource for each type of resource. The first edge server 1 convolutes the number of calculated search hops and the acquired request frequency for each type of resource. Using resultant values acquired by convolution for each type pf resource, the first edge server 1 narrows down to the predetermined resource. With such configuration, the first edge server 1 may narrow down to the predetermined resource that easily becomes depleted, thereby previously searching the predetermined resource to reduce the size of the message at periodical collection.

### Embodiment 2

The edge server 1 according to Embodiment 1 transfers the previous search request to the edge server 1 in the previous search request range (TTL) corresponding to the number of the edge servers 1 in the group. For example, using the previous search request range, the edge server 1 transfers the previous search request to all edge servers 1 in the group. For example, the previous search request range is represented by the number of hops. For example, when the number of edge servers 1 in the group is two, the number of hops is set to 1. However, the edge server 1 is not limited to this, and may use the previous search request range to transfer the previous search request to the edge servers 1 in the group as well as the edge servers 1 out of the group. For example, the previous search request range may be determined depending on the number of edge servers in the system or the number of massages.

Thus, the case where an edge server 1 according to Embodiment 2 uses the previous search request range to transfer the previous search request to the edge servers 1 in the group as well as the edge servers 1 out of the group will be described below.

### Configuration of Edge Server According to Embodiment 2

The configuration of the edge server 1 according to Embodiment 2 is the same as the configuration of the edge server 1 according to Embodiment 1 in FIG. 1 and thus, redundant description of the configuration and operation is omitted.

[Flow of Data Collection Processing]

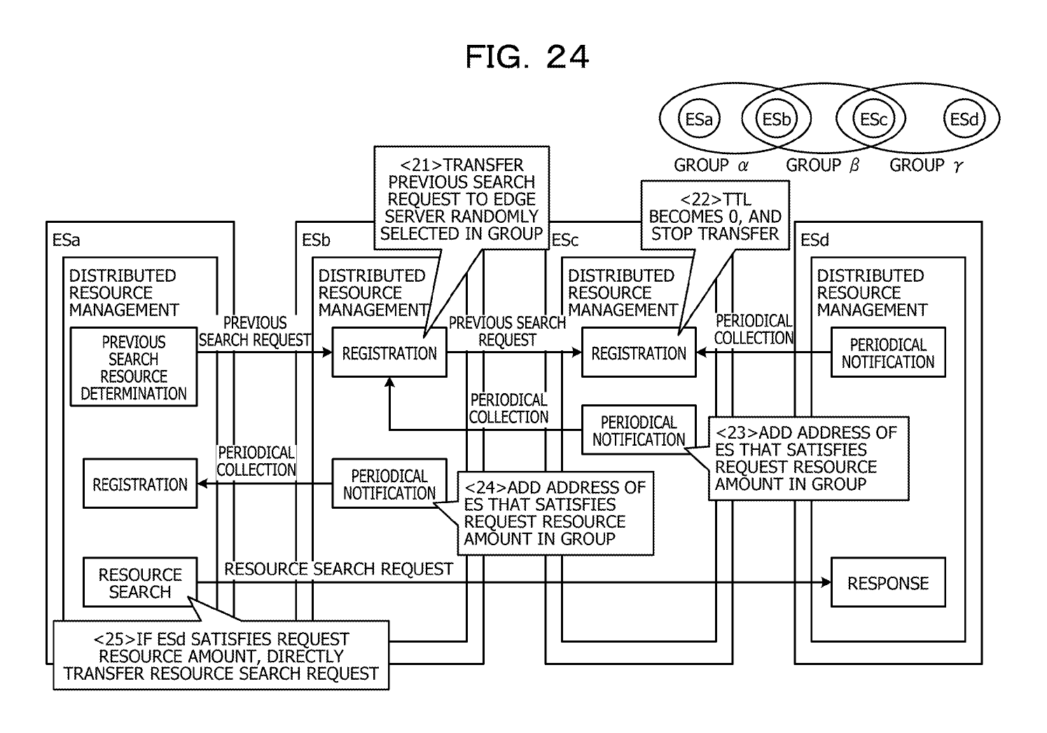

FIG. 24 is a diagram illustrating an example of a flow of data collection processing according to Embodiment 2. In FIG. 24, a, b, c, and d each are the edge server 1. a and b belong to a group α. b and c belong to a group β. c and d belong to a group γ. b, c belong to a plurality of groups. Redundant description of the processing and the data collection processing according to Embodiment 1 in FIG. 5 is omitted here. In the example illustrated in FIG. 24, TTL as the previous search request range is set to “2”.

In the edge server a, the previous search resource determination unit 13 transmits the previous search request to the edge server b in the group α. The previous search request include resource information and TTL of “2”.

In the edge server b, when receiving the previous search request, the registration unit 17 registers the resource information included in the previous search request, in the address information 34. In addition, since TTL included in the previous search request is “2”, the registration unit 17 decrements the value of TTL. The registration unit 17 transfers the previous search request to the edge server c randomly selected in the group β (<21>). The previous search request includes resource information and TTL of “1”.

In the edge server c, when receiving the previous search request, the registration unit 17 registers the resource information included in the previous search request, in the address information 34. In addition, since TTL included in the previous search request is “1”, the registration unit 17 decrements the value of TTL. Then, since TTL becomes 0, the registration unit 17 stops the transfer of the previous search request (<22>).

In the edge server c, when receiving the periodical notification message, the registration unit 17 registers resource value information related to the edge server d that is the notification source in the group γ. The periodical notification unit 14 performs periodical notification to the edge server b in the same group β at a time predetermined by a periodical timer (<23>). For example, if the edge server 1 that satisfies the request resource amount for the previous search resource is present, the periodical notification unit 14 transmits a periodical notification message including an address of this edge server 1 in addition to the resource value information related to all resources of the own edge server 1, to the edge server b. Here, if the edge server d is present as the edge server 1 that satisfies the request resource amount for the previous search resource, the periodical notification unit 14 transmits the periodical notification message further including the address of the edge server d to the edge server b.

In the edge server b, when receiving the periodical notification message, the registration unit 17 registers resource value information related to the edge server c that is the notification source in the group β. The periodical notification unit 14 performs periodical notification to the edge server a in the same group α at a time predetermined by a periodical timer (<24>). For example, if the edge server 1 that satisfies the request resource amount for the previous search resource is present, the periodical notification unit 14 transmits a periodical notification message including an address of this edge server 1 in addition to the resource value information related to all resources of the own edge server 1, to the edge server a. Here, if the edge server d is present as the edge server 1 that satisfies the request resource amount for the previous search resource, the periodical notification unit 14 transmits the periodical notification message further including the address of the edge server d to the edge server a.

In the edge server a, when receiving the periodical notification message, the registration unit 17 registers resource value information related to the edge server b that is the notification source in the group α. In addition, if the address of the edge server d is added to the periodical notification message, the registration unit 17 registers the address of the edge server d out of the group and the type of the resource in the address information 34.

In the edge server a, it is assumed that a resource in the group a exceeds a threshold value. Then, the resource search unit 15 determines whether or not an address out of the group that satisfies the request resource amount of the resource exceeding the threshold value is present. If the address out of the group that satisfies the request resource amount of the resource exceeding the threshold value is present, the resource search unit 15 transmits the resource search request to the edge server c at the address. Here, if the edge server d satisfies the request resource amount for the previous search resource, the edge server a directly transmits the resource search request to the edge server d (<25>).

In Embodiment 2, the previous search request range is determined depending on the number of edge servers in the system or the number of messages. However, the previous search request range is not limited to this, and may be determined from the average number of search hops indicated in the scarcity level information 31. It is due to that the average number of search hops is the average number of hops requested to satisfy the request resource amount in searching the request resource amount of the resource.

### Effects of Embodiment 2

According to Embodiment 2, the edge server 1 may recognize the usage state of the previous search resource in the edge server 1 deriving in the group as well as the edge server 1 out of the group. As a result, even if the previous search resource becomes depleted in the group, the edge server 1 may reduce the time requested to search the edge server 1 that satisfies the request resource amount of the previous search resource. The edge server 1 may suppress the number of messages requested for searching the previous search resource.

In Embodiments 1 and 2, when the resource in the group exceeds the threshold value, the resource search unit 15 determines whether or not the edge server 1 that satisfies the request resource amount of the exceeding resource (search resource) is present out of the group. If the search resource is absent out of the group, the resource search unit 15 transmits the resource search request for the search resource to the edge server 1 having a small delay in the network, which is found based on topology information. However, the resource search unit 15 is not limited to this, and may transmit the resource search request for the search resource to randomly selected one of the edge servers 1 in the group. Further, in the edge server 1 that received the resource search request, if the own edge server 1 does not satisfy the request resource amount of the search resource, and other edge servers 1 do not satisfy the request resource amount of the search resource, the response unit 16 executes following processing. The response unit 16 does not transfer the re-search request to the resource search request source, but randomly selects one of other edge servers 1, and transmits the resource search request for the search resource to the selected edge server 1. This may reduce the number of messages of the re-search request transmitted by the edge server 1 that received the resource search request when the search resource exceeds the threshold value.

[Others]

According to Embodiments 1 and 2, each components of the illustrated devices is not necessarily configured physically as illustrated. For example, the specific distribution and integration modes of the devices are not limited to the illustrated modes, and whole or a part of the devices may be functionally or physically distributed or integrated in any unit depending on various loads and usage states. For example, the previous search resource determination unit 13, the periodical notification unit 14, the resource search unit 15, the response unit 16, and the registration unit 17 may be integrated into the distributed resource management unit 12. For example, the data reception unit 18, the data and task management unit 19, the task deployment place determination unit 20, and the task execution unit 21 may be integrated into a task scheduler unit. For example, the registration unit 17 may be distributed to a processing unit in the case of receiving the previous search request and a processing unit in the case of receiving the periodical notification message. For example, the response unit 16 may be distributed to a processing unit in the case of receiving the resource search request and a processing unit in the case of receiving the re-search request. The storage unit 30 may be connected as an external device of the edge server 1 via a communication network.

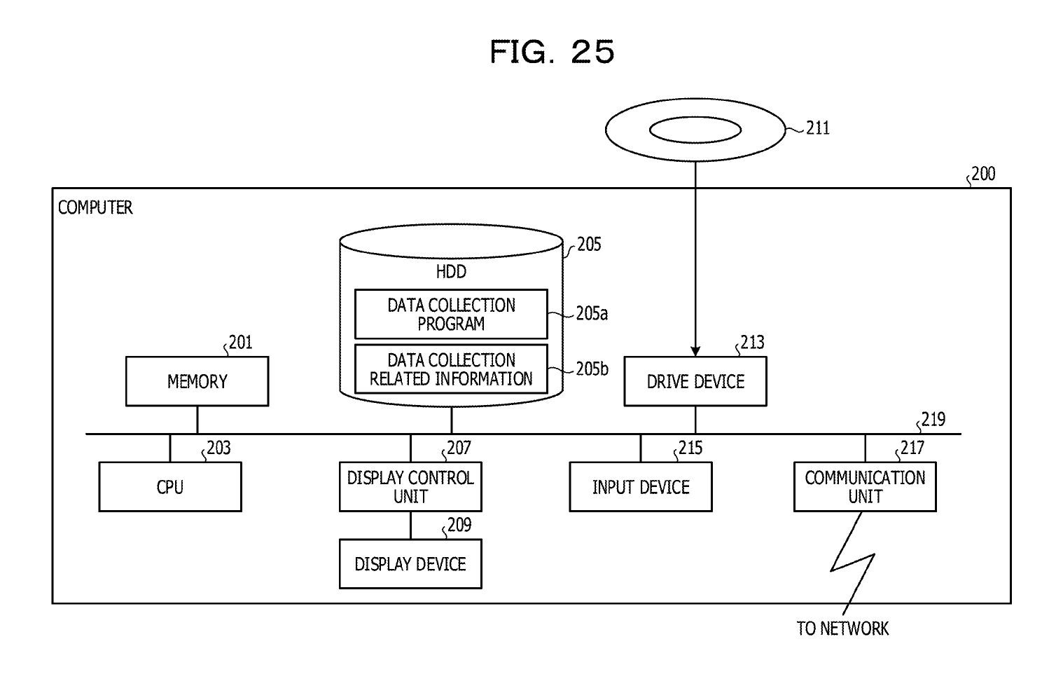

Various processing described in Embodiments may be implemented by causing a computer such as a personal computer or a workstation to execute a previously prepared program. An example of the computer that executes a data collection system performing the same functions as the edge server 1 illustrated in FIG. 1 will be described below. FIG. 25 illustrates an example of the computer that executes the data collection program.

As illustrated in FIG. 25, a computer 200 has a CPU 203 that executes various arithmetic processing, an input device 215 that accepts an input of data from the user, and a display control unit 207 that controls a display device 209. The computer 200 has a drive device 213 that reads a program and the like from a storage medium, and a communication control unit 217 that exchanges data with other computers via a network. The computer 200 has a memory 201 that temporarily stores various information, and an HDD (Hard Disk Drive) 205. The memory 201, the CPU 203, the HDD 205, the display control unit 207, the drive device 213, the input device 215, and the communication control unit 217 are interconnected via a bus 219.

The drive device 213 is, for example, a device for a removable disc 211. The HDD 205 stores a data collection program 205a and data collection related information 205b.

The CPU 203 reads the data collection program 205a, expands the program in the memory 201, and executes the program as a process. Such process corresponds to each function unit of the edge server 1. The data collection related information 205b corresponds to information stored in the storage unit 30 of the edge server 1. For example, the removable disc 211 stores various information including the data collection program 205a.

The data collection program 205a is not necessarily stored in the HDD 205 in advance. For example, the program may be stored in any suitable “portable physical medium” such as a flexible disc (FD), a CD-ROM (Compact Disk Read Only Memory), a DVD (Digital Video Disk), a magneto-optical disc, and IC card, which is inserted into the computer 200. The computer 200 may read the data collection program 205a from the portable physical medium and execute the data collection program 205a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data collection method executed by a distributed processing system having a plurality of groups, the plurality of groups each having a plurality of information processing apparatuses, the data collection method comprising:
extracting, by a first information processing apparatus among the plurality of information processing apparatuses, a predetermined resource that takes much time to search an information processing apparatus satisfying a request resource amount from among a plurality of resources to be collected;
notifying information related to the extracted predetermined resource to a second information processing apparatus that belongs to a first group of the first information processing apparatus;
periodically collecting, by a second information processing apparatus among the plurality of information processing apparatuses, resource amounts of the plurality of resources to be collected from information processing apparatuses belonging to a second group other than the first group, the second information processing apparatus belonging to the second group;
acquiring an resource amount of the predetermined resource of the information processing apparatuses belonging to the second group from the collected resource amounts at a predetermined timing; and
when the acquired resource amount satisfies a predefined resource amount, periodically notifying apparatus information related to the information processing apparatuses belonging to the second group and the resource amounts of the plurality of resources to be collected by the second information processing apparatus to the first information processing apparatus.

2. The data collection method according to claim 1, further comprising when the resource amount of the predetermined resource is not satisfied in the first group, searching the information processing apparatuses included in the second group, the information processing apparatuses being expected to satisfy the resource amount of the predetermined resource, for the predetermined resource, by using the first information processing apparatus.

3. The data collection method according to claim 1, wherein the extracting includes:
calculating, for each type of resource, an average number of search hops requested to search the information processing apparatus that satisfies the request resource amount by using a number of information processing apparatuses that do not satisfy the request resource amount;
acquiring, for each type of resource, request frequency of requests to the resource;
convoluting, for each type of resource, calculated number of search hops and the acquired request frequency; and
extracting the predetermined resource based on values found as a result of convolution for each type of resource.

4. The data collection method according to claim 3, wherein the extracting includes selecting a predetermined number of resources from the plurality of resources in a descending order of the values found as the result of convolution.

5. An information processing apparatus comprising:
a memory; and
a processor coupled to the memory and configured to:
receive information related to a predetermined resource that takes much time to search an information processing apparatus satisfying a request resource, from a first information processing apparatus belonging to a first group to which the information processing apparatus belong;
periodically collect resource amounts of a plurality of resources to be collected, from a second information processing apparatus belonging to a second group other than the first group;
acquire a resource amount of the predetermined resource of the second information processing apparatus from the collected resource amounts at a predetermined timing; and
when the acquired resource amount satisfies a predefined resource amount, periodically notify apparatus information related to the information processing apparatuses belonging to the second group and the resource amounts of the plurality of resources to be collected by the second information processing apparatus to the first information processing apparatus.

6. A distributed processing system having a plurality of groups, the plurality of group each having a plurality of information processing apparatuses, the distributed processing system comprising:
a first information processing apparatus configured to:
extract a predetermined resource that takes much time to search an information processing apparatus satisfying a request resource amount from among a plurality of resources to be collected, and
notify information related to the extracted predetermined resource to a second information processing apparatus that belongs to a first group of the first information processing apparatus; and
the second information processing apparatus configured to:
periodically collect resource amounts of the plurality of resources to be collected from information processing apparatuses belonging to a second group other than the first group, the second information processing apparatus belonging to the second group,
acquire a resource amount of the predetermined resource of the information processing apparatuses belonging to the second group from the collected resource amounts at a predetermined timing, and
when the acquired resource amount satisfies a predefined resource amount, periodically notify apparatus information related to the information processing apparatuses belonging to the second group and the resource amounts of the plurality of resources to be collected by the second information processing apparatus to the first information processing apparatus.

7. The distributed processing system according to claim 6, wherein the second information processing apparatus is configured to
when the resource amount of the predetermined resource is not satisfied in the first group, search the information processing apparatuses included in the second group, the information processing apparatuses being expected to satisfy the resource amount of the predetermined resource, for the predetermined resource, by using the first information processing apparatus.

8. The distributed processing system according to claim 6, wherein the first information processing apparatus is configured to:
calculate, for each type of resource, an average number of search hops requested to search the information processing apparatus that satisfies the request resource amount by using a number of information processing apparatuses that do not satisfy the request resource amount,
acquire, for each type of resource, request frequency of requests to the resource;
convolute, for each type of resource, calculated number of search hops and the acquired request frequency, and
extract the predetermined resource based on values found as a result of convolution for each type of resource.

9. The distributed processing system according to claim 8, wherein the first information processing apparatus is configured to
select a predetermined number of resources from the plurality of resources in a descending order of the values found as the result of convolution.
